(19) United States
(12) Patent Application Publication
(10) Pub. No.: US 2006/0011612 A1
(43) Pub. Date: Jan. 19, 2006

(54) Control panel for an electrical appliance and method for manufacturing the control panel

(75) Inventors: Edmund Illerhaus, Bergatreute (DE); Werner Kaps, Weiler-Simmerberg (DE)

Correspondence Address: LERNER AND GREENBERG, PA, P O BOX 2480, HOLLYWOOD, FL, 33022-2480, US

(73) Assignee: Diehl AKO Stiftung & Co. KG

(21) Appl. No.: 11/179,203

(22) Filed: Jul. 12, 2005

(30) Foreign Application Priority Data
Jul. 12, 2004 (DE) 10 2004 033 656.3
Sep. 9, 2004 (DE) 10 2004 043 578.2

(51) Int. Cl. H05B 3/68

(52) U.S. Cl. 219/447.1

(57) ABSTRACT

In order to enable an electrical appliance, in particular for a domestic appliance, an economically produced control panel for different models of the appliance is provided. The control panel has a sensor film forming a switch panel with a plurality of individual switch zones. Each of the switch zones can be selected independently of each other. A specific selection of the switch zones is activated depending on what devices are fitted in the electrical appliance. In addition, the sensor film is assigned an externally accessible keypad having a plurality of individual visually identified button zones assigned to each of the activated switch zones. The sensor film is in particular a film having a printed piezo-layer from which the individual switch zones are formed.

### BACKGROUND OF THE INVENTION

### FIELD OF THE INVENTION

The invention relates to a control panel for an electrical appliance, in particular for a domestic appliance, and a method for manufacturing such a control panel.

With domestic appliances, in particular with “white goods” such as washing machines, tumble driers, dish washing machines etc., a manufacturer normally offers a very large range of models of an appliance type, for example of a dishwasher. The various models differ particularly here with regard to their technical functions and/or their visual configuration.

The appliances are operated by the user via a control panel. The control panel normally contains a plurality of individual controls such as buttons or rotary controls. A dedicated control panel is necessary for each model of an appliance type owing to the large variety of models. The control panels for different models differ for example here in the number of controls and/or the positioning of the controls. Since a dedicated control panel needs to be provided and stocked with components for each model, this leads to high model-specific costs.

Membrane keypads are also known as one form of control panel, in which the different buttons and mechanical components of the buttons are covered by a film. A method for embedding a pressure sensor film in a foam-type material for example is described in European patent EP 0 829 891 B1.

In addition, a pressure-sensitive sensor film for providing, for example, pressure-sensitive buttons or keypads, is described in European patent EP 0 576 400 B1 (corresponding to U.S. Pat. No. 5,374,449). These films are provided with individual piezoelectric elements using a type of printing technology so that a plurality of pressure-sensitive pressure zones are formed on the film.

### SUMMARY OF THE INVENTION

It is accordingly an object of the invention to provide a control panel for an electrical appliance and a method for manufacturing the control panel which overcomes the above-mentioned disadvantages of the prior art devices and methods of this general type, which enables a large variety of models and hence a high level of variability with regard to the configuration of an electrical appliance while keeping costs low.

The object is achieved according to the invention by a control panel for an electrical appliance, in particular for a domestic appliance, having an appliance-independent technical functional component that contains a sensor film forming a switch panel having a plurality of individual switch zones, each of which can be selected independently of each other. Usually only a specific selection of the switch zones is activated depending on what devices are fitted in the electrical appliance. In addition, an externally accessible keypad is provided having a plurality of individual visually identified button zones assigned to each of the activated switch zones.

Each of the individual visually identified button zones is here disposed directly in front of the activated switch zones. The button zones themselves are normally irrelevant to the switching function, i.e. the provision of electrical signals. They are used merely for visual identification of the position of the activated switch zones. The number of visually identified button zones therefore equals the number of activated switch zones. Usually only some of the available switch zones are activated, so that the number of activated and used switch zones is less than the total number of switch zones available on the sensor film.

This embodiment is based on the idea of connecting and combining a model-independent, and hence appliance-independent, technical functional component containing the sensor film with an appliance-specific, externally accessible visual functional component (keypad), wherein only the required switch zones of the sensor film are activated i.e. only a number of the switch zones are operational after final assembly. This measure results in that just one standardized sensor film is sufficient for all models, which can hence be manufactured in large numbers and hence economically.

The individual switch zones are preferably activated via a selection of the individual switch zones. In addition to the individual switch zones, conductor tracks are normally integrated on the sensor film for electrical selection of the switch zones. These are taken, for example via a cable loom, to an adapter or connector that constitutes an interface to an appliance controller. The particular switch zones that are needed depending on the required configuration of the given model are activated or “enabled” by a corresponding selection. The selection is performed either purely in software and/or in hardware or a combination of software and hardware. In the second case, an adapter or connector is preferably provided via which only selected conductor tracks are connected. Some of the contacts of the connector are not fitted. The configuration of the whole controller hardware is preferably also independent of the model. Only the software used or the adapters/connectors via which the selection of the sensor film is made are model specific.

According to a useful development, the sensor film is pressure sensitive and contains a plurality of individual pressure zones. A switch zone is therefore actuated by applying pressure. In particular, the film is formed with integrated conductor tracks and a printed piezo-layer, pressure zones being defined via the printed piezo-layer, and each individual pressure zone being formed as a piezo-element. Such a piezo sensor-film is described for example in European patent EP 0 576 400 B1 (corresponding to U.S. Pat. No. 5,374,449). The key advantage of such a film lies in the electrical functionality, i.e. the individual piezo-elements and their connection via the integrated conductor tracks, being printed on a polyester film, for example, in a simple and economic manner using printing technology. Thus such a piezo sensor-film can be manufactured almost as “piece goods”. In this case the production costs are set mainly by the size of the sensor film and less by the number of pressure zones integrated on the sensor film. In this respect, not activating a few or more of the integrated switch zones is uncritical from the cost viewpoint.

Instead of the pressure-sensitive embodiment of the switch zones, in an alternative embodiment these are formed as capacitive or proximity switches, for example.

According to a useful embodiment, the keypad is configured as a control plate having a plurality of buttons or button zones, the buttons being assigned to the individual activated switch zones. The buttons in this case are in particular pushbuttons that act on the switch zones, i.e. they exert a pressure on the zones when pushed. The control plate is the whole front panel of a household appliance, for example, or alternatively in a preferred version it is configured as an insert fitted in the front panel.

According to a useful embodiment the control plate is an injection molding and the sensor film is embedded in the control plate, in particular fully embedded. In injection molding, the sensor film is thus placed in a suitable mold and surrounded with the plastic material. Only the electrical connections, i.e. the cable loom provided on the sensor film, extends out of the embedding. This measure results in that a hermetic seal of the electrical component is already achieved when the control panel is manufactured, and no further precautions need to be taken at final assembly to protect against moisture or the like.

In order to increase the variability and reduce costs, it is provided according to a useful development that the control plate contains a plurality of technical function-button zones, wherein only a specific selection of the individual function-button zones are formed as visually identifiable button zones, i.e. as buttons, depending on what devices are fitted in the electrical appliance. Thus by this measure, in a similar way to the sensor film, an initially appliance-independent control plate is provided with an array-type configuration, for example, of the function-button zones only visual identification of those button zones that are needed and placed in front of the activated switch zones depends on the given model. In the simplest version here, the appliance-independent function control plate is formed as the injection molding in which the sensor film is integrated, because owing to the high sensitivity, in particular of the sensor film with the printed piezo-layer, no separate button elements passing through holes in the control plate are required.

In order to identify the position of the individual button zones and hence the activated switch zones, a printed pattern is preferably applied to the control plate or a film bonded over it on which the individual button zones are visually represented. With a sufficiently large sensor film, a different selection of the positions of the individual button zones or buttons can be made over a large area, so that the widest range of models, in particular also in terms of visual appearance, can be formed in a simple manner.

In addition, decoupling elements, for instance ribs, a lattice structure or the like are usefully disposed between the individual button zones, providing decoupling, in particular mechanical decoupling, between adjacent function-button zones. This measure guarantees a precisely defined actuation of the respective activated switch zones when the assigned button zone is pressed and avoids malfunctions. A precise spatial resolution of the exerted pressure is thus achieved by the decoupling elements.

The object is also achieved according to the invention by a method for manufacturing a control panel. The preferred embodiments and advantages cited for the control panel shall also apply analogously to the method. The method is characterized in that first an appliance-independent “technical” component is manufactured in large numbers and the configuration, i.e. the specification of which of the pressure zones are activated, is not performed until the domestic appliance is assembled. The technical component here is in particular the plastic injection molding, formed as a control plate, together with the integrated sensor film. For configuration at final assembly, first a printed pattern is applied or a film is bonded onto the control plate in order to identify visually the button zones, and second the required switch zones are actuated by the software selection and/or hardware selection.

Other features which are considered as characteristic for the invention are set forth in the appended claims.

Although the invention is illustrated and described herein as embodied in a control panel for an electrical appliance and a method for manufacturing the control panel, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a diagrammatic, rear view of a control plate, formed from injection molding, with an embedded sensor film, according to the invention;

FIG. 1B is a diagrammatic, rear view of the sensor film embedded in the control plate as shown in FIG. 1A prior to the injection molding process;

FIGS. 2A and 2B are diagrammatic, sectional views each showing the sensor film with a printed piezo-layer;

FIG. 3 is a diagrammatic, cross-sectional view through the control plate with the embedded sensor film; and

FIG. 4 is an illustration of the sensor film having a plurality of individual switch zones.

### DESCRIPTION OF THE PREFERRED EMBODIMENTS

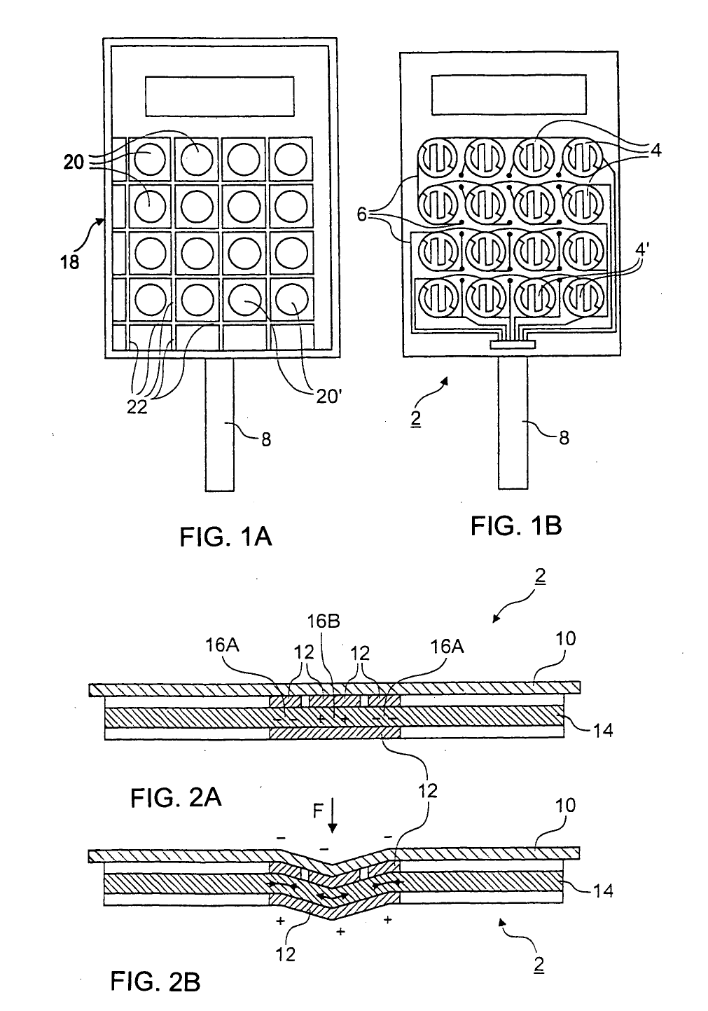

In all the figures of the drawing, sub-features and integral parts that correspond to one another bear the same reference symbol in each case. Referring now to the figures of the drawing in detail and first, particularly, to FIGS. 1A and 1B thereof, there is shown a pressure-sensitive sensor film 2 which contains a plurality of individual pressure zones 4 each formed by an individually selectable piezo-element. The sensor film 2 is formed overall like a sensor panel having the pressure zones 4 disposed in an array. The individual pressure zones 4 are here selectable via conductor tracks 6 that are brought together in a cable loom 8. The individual conductor tracks 6 and the individual piezo-elements for forming the individual pressure zones 4, are printed onto a film-type base material, for example a polyester film.

FIGS. 2A and 2B show a schematic cross-section through the film 2, in one case not under load, and in one case with pressure applied, FIG. 2B. The sensor film 2 contains a base film 10 onto which an electrode 12, for example a carbon layer, a piezo-layer 14 made of a piezo-active material and another electrode 12 are applied in succession. The electrodes 12 are used for making electrical contact with the piezo-layer 14 via the conductor tracks 6. The electrodes 12 are physically restricted to the area of the pressure zone 4, i.e. they define the position of the pressure zone 4. Within the piezo-layer 14 are areas 16A, 16B having negative and positive polarization respectively. When pressure is applied with a force F in the direction of the arrow shown in FIG. 2B, the sensor film 2 is deformed which, owing to the piezoelectric effect, results in a voltage signal being generated, which is transmitted as a switching signal via the individual conductor tracks 6 to a control unit not shown here.

Owing to the manufacturing technique of the sensor film 2 based on printing process steps, the manufacturing costs of the sensor film 2 are substantially independent of the number of the individual pressure zones 4. They depend solely on the overall size of the sensor film 2.

In order to form a control panel, the rear side of which is shown in FIG. 1A, the sensor film 2 in the exemplary embodiment of FIGS. 1A and 1B is embedded in a control plate 18 by injection molding. The control plate 18 in turn contains a multiplicity of individual function-button zones 20, as shown in FIG. 1A, which are disposed here in the same array-type configuration as the individual pressure zones 4. In the exemplary embodiment of FIG. 1A, the individual function-button zones 20 are formed by a circular region, each centrally positioned, having a reduced wall thickness and bounded laterally by ribs 22 disposed like a lattice. These form decoupling elements for explicit and precise actuation of the underlying pressure zone 4 when pressure is applied to the individual function-button zones 20.

The combined component shown in FIG. 1A made of the sensor film 2 and the control plate 18 still has a model-independent configuration that can be used for the widest range of models of an appliance type, for example a washing machine or dishwasher or other domestic appliance of the “white goods” type or even an electronic home-entertainment device. The appliance-specific configuration with regard to the pressure zones 4 is achieved by a corresponding selection or enabling of the required pressure zones 4, which then provide their functions as activated pressure zones 4′ (in FIG. 1B, for example two pressure zones are labeled with the reference 4′). The selection is performed in software here, i.e. only the signals output from the pressure zones 4′ of interest (activated pressure zones 4′) via the interface to a control unit are evaluated or only the activated pressure zones 4′ are electrically connected.

With regard to the control plate 18, the appliance-specific configuration is achieved by a visual identification of the respective function-button zones 20, so that visually identifiable button zones 20′ are formed. This is achieved, for example, by applying a film or a printed pattern on the front face of the control plate 18 (for example in FIG. 1A two button zones labeled 20′ are provided).

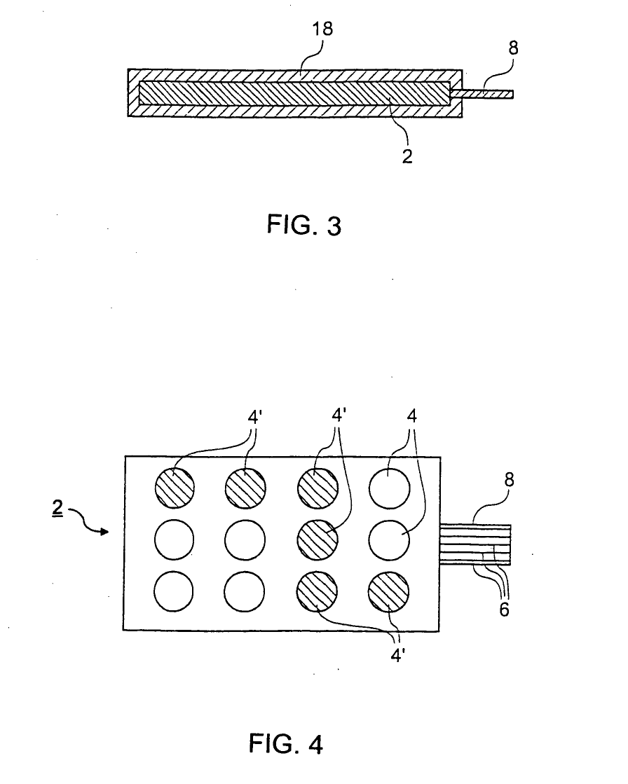

The complete embedding of the sensor film 2 in the control plate 18 can be seen in FIG. 3. Only the cable loom 8 extends out of the embedding. The sensor film 2 as such is thereby hermetically sealed. Alternatively, the sensor film 2 is only partially embedded, i.e. the sensor film 2 is only partially enclosed by the plastic material, and a sub-section of the rear side of the sensor film 2 remains exposed for example.

According to FIG. 4, the sensor film 2 contains a plurality of pressure zones 4 disposed in an array, only some of the zones being activated via the selection. These form the activated pressure zones 4′ shown hatched.

This application claims the priority, under 35 U.S.C. § 119, of German patent application No. 10 2004 033 656.3, filed Jul. 12, 2004 and German patent application No. 10 2004 043 578.2, filed Sep. 9, 2004; the entire disclosures of the prior applications are herewith incorporated by reference.

We claim:

1. A control panel for an electrical appliance, comprising:
an appliance-independent technical functional component having a sensor film forming a switch panel with a plurality of individual switch zones, each of said individual switch zones can be selected independently of each other, and a specific selection of said individual switch zones being activated depending on what devices are fitted in the electrical appliance resulting in activated individual switch zones; and
an externally accessible keypad having a plurality of individual visually identified button zones assigned to each of said activated individual switch zones.

2. The control panel according to claim 1, wherein a selection of said activated individual switch zones is made via a selection of said individual switch zones.

3. The control panel according to claim 1, wherein said sensor film is pressure sensitive and contains said plurality of individual switches zones being pressure zones.

4. The control panel according to claim 3, wherein said sensor film is a film with integrated conductor tracks and a printed piezo-layer having piezo-elements via which said pressure zones are defined, each of said pressure zones being formed from one of said piezo-elements.

5. The control panel according to claim 1, wherein said appliance-independent technical functional component is a control plate having said plurality of individual visually identified button zones assigned to said individual switch zones disposed thereon.

6. The control panel according to claim 5, wherein said control plate is formed by injection molding and said sensor film is embedded in said control plate.

7. The control panel according to claim 5, wherein said sensor film is fully embedded in said control plate.

8. The control panel according to claim 5, wherein said control plate contains a plurality of technical function button zones, a specific selection of said technical function button zones form said visually identifiable button zones depending on what devices are fitted in the electrical appliance.

9. The control panel according to claim 8, wherein for forming said individual visually identifiable button zones, a printed pattern is applied to said control plate or a film is bonded to said control plate.

10. The control panel according to claim 8, further comprising decoupling elements disposed between individual ones of said technical function button zones by which a pressure-decoupling between adjacent ones of said technical function button zones is provided.

11. The control panel according to claim 1, wherein the electrical appliance is a domestic appliance.

12. A method for manufacturing a control panel for an electrical appliance in which an appliance-independent technical functional component is provided and contains a sensor film forming a switch panel having a plurality of individual switch zones, which comprises the steps of:
performing an appliance-specific activation of the individual switch zones in dependence on what devices are fitted in the electrical appliance; and
providing the appliance-independent technical functional component with an appliance-specific externally accessible keypad having a plurality of individual visually identified button zones.

13. The method according to claim 12, wherein for forming the appliance-independent technical functional component, performing the steps of:
injecting molding the sensor film; and
forming an appliance-independent control plate on which the individual visually identified button zones are applied.
